(19) United States
(12) Patent Application Publication
(10) Pub. No.: US 2026/0163143 A1
(43) Pub. Date: Jun. 11, 2026

(54) CURRENT COLLECTING TERMINAL

(71) Applicant: TOYOTA JIDOSHA KABUSHIKI KAISHA, Toyota-shi Aichi-ken (JP)

(72) Inventor: Tsuyoshi Ehara, Toyota-shi Aichi-ken (JP)

(73) Assignee: TOYOTA JIDOSHA KABUSHIKI KAISHA, Toyota-shi Aichi-ken (JP)

(21) Appl. No.: 19/404,682

(22) Filed: Dec. 1, 2025

(30) Foreign Application Priority Data
Dec. 5, 2024 (JP) 2024-212299

(51) Int. Cl. H01M 50/184; H01M 50/105; H01M 50/178; H01M 50/186; H01M 50/531

(52) U.S. Cl. CPC H01M 50/184; H01M 50/105; H01M 50/178; H01M 50/186; H01M 50/531

(57) ABSTRACT

The present disclosure provides a current collecting terminal having improved adhesion to a laminate exterior body. The current collecting terminal for a pouch battery of the disclosure is a current collecting terminal for a pouch battery, wherein the pouch battery has a laminate exterior body, an electrode stack housed in the laminate exterior body, and the current collecting terminal, wherein the current collecting terminal has a current collector-connecting portion for electrically connecting to a current collector of the electrode stack, an external terminal-connecting portion for electrically connecting to an external terminal, and an intermediate portion between the current collector-connecting portion and the external terminal-connecting portion, and wherein, in the intermediate portion, concave portions and convex portions are arranged alternately over the width direction thereof.

### CROSS-REFERENCE TO RELATED APPLICATIONS

This application claims priority to Japanese Patent Application No. 2024-212299 filed Dec. 5, 2024, the entire contents of which are herein incorporated by reference.

### TECHNICAL FIELD

The present disclosure relates to a current collecting terminal.

### BACKGROUND

PLT 1 discloses a battery comprising: an electrode body; a plurality of current collector tabs extending from a side surface portion of the electrode body; a current collector terminal connected to the current collector tabs; and a laminate film housing the electrode body and the current collector tabs, wherein: each of the current collector tabs includes a root portion that is an end portion on the electrode body side, a connection portion for connecting to the current collector terminal, and an intermediate portion connecting the root portion and the connection portion; the current collector tabs include a laminated connection portion in which the respective connection portions of the current collector tabs are laminated in a thickness direction; the current collector terminal includes an inner surface facing the side surface portion of the electrode body, and a side surface disposed along an outer edge of the inner surface; the laminate film is disposed on the side surface of the current collector terminal; a main surface of the laminated connection portion is joined to the inner surface; and in a plan view in a laminating direction of the electrode body, the current collector terminal includes a base portion including a first end portion corresponding to a position of the inner surface and a second end portion opposite to the first end portion, and a protruding portion protruding from the base portion to an opposite side of the base portion from the electrode body.

### CITATION LIST

### Patent Literature

[PTL 1] Japanese Unexamined Patent Publication No 2024-003420

### SUMMARY

### Technical Problem

The pouch battery (a laminate battery) may have a laminate exterior body, an electrode stack housed within the laminate exterior body, and a current collecting terminal. The current collecting terminals can have a current collector-connecting portion, an external terminal-connecting portion, and an intermediate portion between the current collector-connecting portion and the external terminal-connecting portions. The current collector-connecting portion is a portion for electrically connecting to the current collector of the electrode stack. The external terminal-connecting portion is a portion for electrically connecting to the external terminal. The intermediate portion is a portion in which all or a portion thereof is bonded to the laminate exterior body to seal the electrode stack in the laminate exterior body.

In the above configuration, when the adhesion between the laminate exterior body and the current collecting terminal is not sufficient, there is a possibility that the laminate exterior body and the current collecting terminal are separated from each other. Peeling between the laminate exterior body and the current collecting terminal can cause imperfections in the sealing of the electrode stack.

The present disclosure provides a current collecting terminal having improved adhesion to a laminate exterior body.

The present inventors have found that the aforementioned object can be achieved by the following aspects.

### <<Aspect 1>>

A current collecting terminal for a pouch battery,
wherein the pouch battery has a laminate exterior body, an electrode stack housed in the laminate exterior body, and the current collecting terminal,
wherein the current collecting terminal has
   a current collector-connecting portion for electrically connecting to a current collector of the electrode stack,
   an external terminal-connecting portion for electrically connecting to an external terminal, and
   an intermediate portion between the current collector-connecting portion and the external terminal-connecting portion, and
wherein, in the intermediate portion, concave portions and convex portions are arranged alternately over the width direction thereof.

### <<Aspect 2>>

The current collecting terminal according to Aspect 1, wherein, in a region including a length-direction center line of the intermediate portion, the concave portions and the convex portions are alternately arranged over a width direction thereof.

### <<Aspect 3>>

The current collecting terminal according to Aspects 1 or 2, wherein, in at least a part of the external terminal-connecting portion, concave portions and convex portions are alternately arranged over the width direction thereof.

### Effects of Present Disclosure

According to the present disclosure, it is possible to provide a current collecting terminal having improved adhesion to a laminate exterior body.

### BRIEF DESCRIPTION OF DRAWINGS

FIG. 1 is a schematic diagram of a current collecting terminal 1 according to one embodiment of the present disclosure.

FIG. 2 is a schematic view of a current collecting terminal 1 in an A-A′ cross section of FIG. 1.

FIG. 3 is a schematic diagram of a pouch battery 20 having a current collecting terminal 1 in accordance with one embodiment of the present disclosure.

FIG. 4A is a schematic diagram of a sample of Comparative Example 1.

FIG. 4B shows the distribution of stresses by CAE analysis (Computer Aided Engineering) of the sample of Comparative Example 1.

FIG. 5A is a schematic diagram of a sample of Example 1.

FIG. 5B shows the distribution of stresses by CAE analysis (Computer Aided Engineering) of the sample of Example 1.

### DESCRIPTION OF EMBODIMENTS

Hereinafter, embodiments of the present disclosure will now be described in detail. The present disclosure is not limited to the following embodiments and can be variously modified and implemented within the scope of the present disclosure.

### 1. Current Collecting Terminal

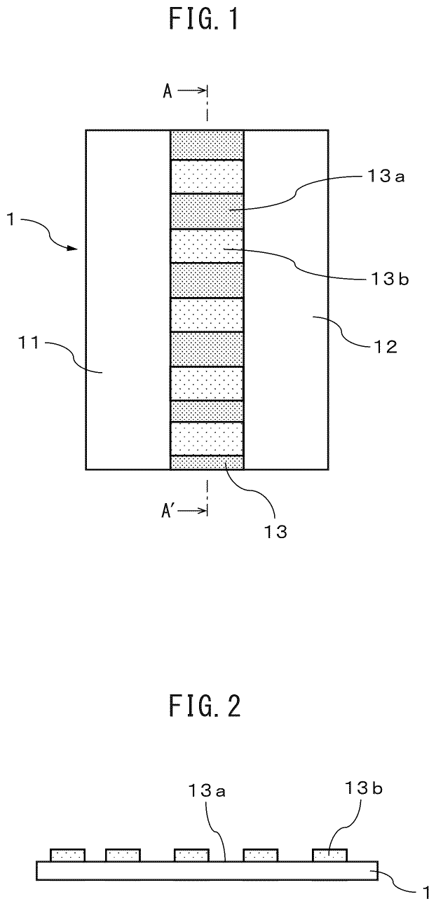

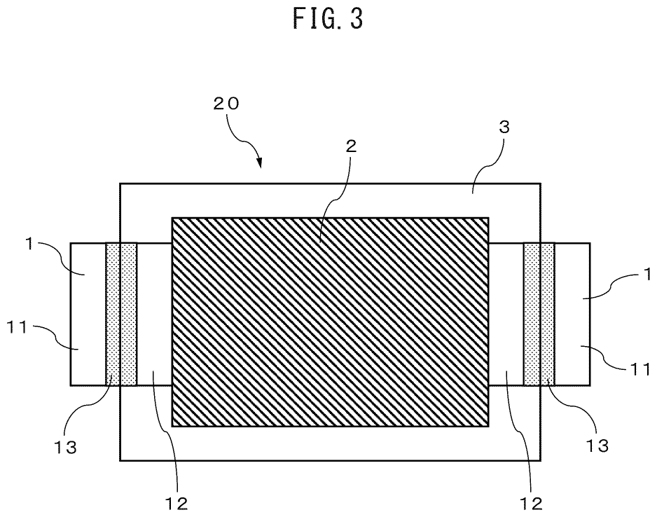

For example, as shown in FIG. 1, the current collecting terminal 1 of the present disclosure is a current collecting terminal 1 for a pouch battery 20. Here, the pouch battery 20 has, for example, as shown in FIG. 3, a laminate exterior body 3, an electrode stack 2 housed in the laminate exterior body 3, and a current collecting terminal 1. The current collecting terminal 1 has a current collector-connecting portion 12 for electrically connecting to the current collector of the electrode stack 2, an external terminal-connecting portion 11 for electrically connecting to the external terminal, and an intermediate portion 13 between the current collector-connecting portion 12 and the external terminal-connecting portion 11. For example, as shown in FIG. 2, the intermediate portion 13, concave portions 13a and convex portions 13b are arranged alternately over the width direction thereof. FIGS. 1 and 2 are not intended to limit the present disclosure.

In the present disclosure, the current collecting terminal has a length direction, a width direction, and a thickness direction. The thickness direction of the current collecting terminal can be a direction that coincides with the thickness direction of the battery stack. The length direction of the current collecting terminal is perpendicular to the thickness direction of the current collecting terminal and is a direction along the external terminal-connecting portion, the intermediate portion, and the current collector-connecting portion. The width direction of the current collecting terminal is a direction perpendicular to the thickness direction and the length direction of the current collecting terminal.

The material of the current collecting terminal may be similar to that used in a current collecting terminal commonly used in a pouch battery. The material of the current collecting terminal may be any conductive material. Specifically, the metal may be selected from the group consisting of aluminum, copper, stainless steel, nickel, zinc, tin, lead, iron, tungsten, gold, and silver.

In the current collecting terminal, the ratio occupied in the length direction of the external terminal-connecting portion, the current collector-connecting portion, and the intermediate portion is not particularly limited, for example, on the basis of the ease of connection to the external terminal of the external terminal-connecting portion, the ease of connection to the current collector of the battery stack of the current collector-connecting portion, and the ease of fusion between the intermediate portion and the laminate exterior body may be appropriately set.

### 1-1. Intermediate Portion

The intermediate portion is located between the external terminal-connecting portion and the current collector-connecting portion. In the intermediate portion, over the width direction thereof, concave portions and convex portions are arranged alternately. When the current collecting terminal constitutes the pouch battery, all or a part of the intermediate portion is configured to be fused to the laminate exterior body.

According to the current collecting terminal of the present disclosure, the adhesive property with the laminate exterior body is improved by the above-described configuration of the intermediate portion. Although not limited by any principle, according to the current collecting terminal of the present disclosure, since the concave portions and the convex portions are alternately arranged in the intermediate portion over the width direction thereof, separation between the laminate exterior body and the intermediate portion can be suppressed. More specifically, it is possible to suppress the peeling between the current collecting terminal and the laminate exterior body due to heat generation caused by charging and discharging of the electrode stack, for example. Heat generation of the electrode stack may heat the current collecting terminal and the laminate exterior body. When the current collecting terminal and the laminate exterior body are heated, stress is generated on the adhesive surface between the current collecting terminal and the laminate exterior body due to the difference in linear expansion, which may reduce the adhesion between them and thus cause peeling. Since the current collecting terminal of the present disclosure has the concave portions and the convex portions arranged alternately over the width direction thereof in the intermediate portion, the stress generated on the adhesive surface between the current collecting terminal and the laminate exterior body can be dispersed at a plurality of the boundary between the concave portions and the convex portions. In other words, it is possible to suppress the stress generated on the adhesive surface from concentrating on a specific portion. Thus, peeling between them can be suppressed.

Although there is no particular limitation on the length and the number in the width direction of the concave portions and the convex portions in the intermediate portion, the number is larger from the viewpoint of suppressing peeling due to the difference in linear expansion. For example, the length in the width direction of the concave portions and the convex portions may be 0.0001 times to 0.25 times the length in the width direction of the intermediate portion, respectively. The length in the width direction of the concave portions and the convex portions may be 0.0001 times or greater, 0.001 times or greater, or 0.01 times or greater of the length in the width direction of the intermediate portion, respectively, and may be 0.25 times or less, 0.1 times or less, or 0.01 times or less, or 0.001 times or less.

The concave portions and the convex portions may be provided, for example, by forming a plurality of grooves in the middle portion of the current collecting terminal. In this case, the bottoms of the grooves become the concave portions. The grooves may have an inclination of 0° to 45° with respect to the length direction. The grooves may be parallel to the length direction.

In the current collecting terminal according to an embodiment, in a region including the longitudinal center line of the intermediate portion, the concave portions and the convex portions are arranged alternately over the width direction thereof. This is because the stress due to the difference in linear expansion can be particularly dispersed in the region including the center point of the intermediate portion.

### 1-2. Current Collector-Connecting Portion

The current collector-connecting portion, when constituting the pouch battery, is a portion for electrically connecting to the current collector of the electrode stack.

### 1-3. External Terminal-Connecting Portion

The external terminal-connecting portion, when constituting the pouch battery, is a portion for electrically connecting to the external terminal. The external terminal-connecting portion protrudes from the laminate exterior body, usually when constituting the pouch battery.

In embodiments, in at least a part of the external terminal-connecting portion, concave portions and convex portions are alternately arranged over the width direction thereof.

Since the concave portions and the convex portions also exist in the external terminal-connecting portion, the surface area of the current collecting terminal is increased in the portion.

Thus, heat dissipation is improved in the external terminal-connecting portion, can be effectively discharged to the outside heat generated inside the pouch battery. Therefore, the difference in linear expansion between the current collecting terminal and the laminate exterior body is also suppressed.

### 2. Pouch Battery

The pouch battery of the present disclosure has the current collecting terminal of the present disclosure. The pouch battery of the present disclosure has a laminate exterior body, an electrode stack housed in the laminate exterior body, and a current collecting terminal.

FIG. 3 is a schematic diagram of a pouch battery 20 having a current collecting terminal 1 in accordance with one embodiment of the present disclosure. The pouch battery 20 has a structure in which the battery stack 2 is housed in the laminate exterior body 3 The current collecting terminal 1 has the external terminal-connecting portion 11, the current collector-connecting portion 12, and the intermediate portion 13. The intermediate portion 13 is located between the external terminal-connecting portion 11 and the current collector-connecting portion 12. Although not shown, the external terminal-connecting portion 11 is configured to electrically connect the pouch battery 20 to the external terminal external circuit has. Although not shown, the current collector-connecting portion 12 is electrically connected to the positive electrode current collector or the negative electrode current collector of the battery stack 2.

### 2-1. Laminate Exterior Body

The laminate exterior body has at least a structure in which a heat fusion layer and a metal layer are laminated. In addition, a laminate film may have a heat fusion layer, a metal layer, and a resin layer in this order along the thickness direction. Examples of the material of the heat fusion layer include olefinic resins such as polypropylene (PP) and polyethylene (PE). Examples of the material of the metal layer include aluminum, aluminum alloy, and stainless steel. Examples of the material of the resin layer include polyethylene terephthalate (PET) and nylon. The thickness of the heat fusion layer is, for example, 40 μm or greater and 100 μm or less. The thickness of the metal layer is, for example, 30 μm or greater and 60 μm or less. The thickness of the resin layer is, for example, 20 μm or greater and 60 μm or less. The thickness of the laminate film is, for example, 80 μm or greater and 250 μm or less.

### 2-2. Electrode Stack

The electrode stack usually includes a power generation unit having a positive electrode current collector, a positive electrode active material layer, an electrolyte layer, a negative electrode active material layer, and a negative electrode current collector in this order in the thickness direction. The electrode body usually has a plurality of power generation units stacked in the thickness direction. A positive electrode current collector and/or a negative electrode current collector can be shared between adjacent power generation units.

A positive electrode current collector, a positive electrode active material layer, an electrolyte layer, a negative electrode active material layer, and a negative electrode current collector may be used, for example, as described in PTL 1.

### EXAMPLES

### Comparative Example 1 and Example 1

### 1.Sample Preparation

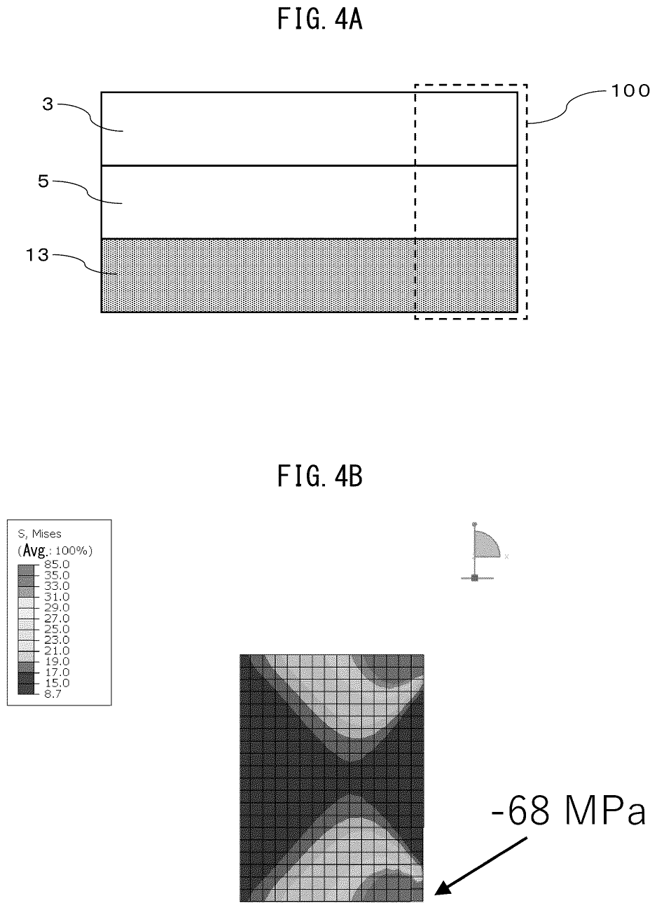

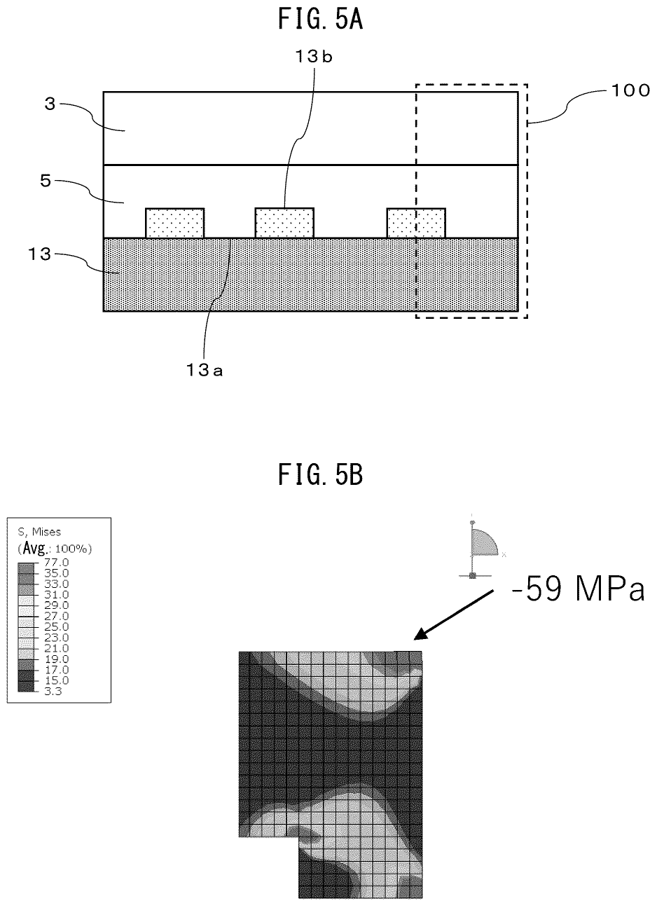

As shown in FIG. 4A, the laminate exterior body and the intermediate portion 13 of the current collecting terminal 1 of Comparative Example 1 were bonded by the adhesive layer 5. Here, in the current collecting terminal used in Comparative Example 1, the concave portions and the convex portions were not provided in the intermediate portion 13. On the other hand, as shown in FIG. 5A, in Example 1, the concave portions 13a and the convex portions 13b are provided in the intermediate portion 13 of the current collecting terminal 1. It is to be noted that, in the measurement site 100 surrounded by the dotted box, the distribution of the stresses was examined by CAE analysis (Computer Aided Engineering).

As shown in FIG. 4B, in Comparative Example 1, at the part of the end of the laminate exterior body 3 and the intermediate portion 13 of the current collecting terminal 1, it was analyzed that 68 MPa stresses are applied. On the other hand, as shown in FIG. 5B, in Example 1, the stresses are dispersed not only at the ends of the laminate exterior body 3 and the intermediate portions 13 of the current collecting terminal 1, but also at the border portions of the concave portions 13a and the convex portions 13b. Then, the stresses according to the end portion of the intermediate portion 13 of the current collecting terminal 1 were 59 MPa and were lower than those of Comparative Example 1.

### REFERENCE SIGNS LIST

1 Current collecting terminal
11 External terminal-connecting portion
12 Current collector-connecting portion
13 Intermediate portion
13a Concave portions
13b Convex portions
2 Electrode stack
3 Laminate exterior body
20 Pouch battery
5 Adhesive layer
100 Measurement site

1. A current collecting terminal for a pouch battery,
wherein the pouch battery has a laminate exterior body, an electrode stack housed in the laminate exterior body, and the current collecting terminal,
wherein the current collecting terminal has
a current collector-connecting portion for electrically connecting to a current collector of the electrode stack,
an external terminal-connecting portion for electrically connecting to an external terminal, and
an intermediate portion between the current collector-connecting portion and the external terminal-connecting portion, and
wherein, in the intermediate portion, concave portions and convex portions are arranged alternately over a width direction thereof.

2. The current collecting terminal according to claim 1, wherein, in a region including a length-direction center line of the intermediate portion, the concave portions and the convex portions are alternately arranged over the width direction thereof.

3. The current collecting terminal according to claim 1, wherein, in at least a part of the external terminal-connecting portion, concave portions and convex portions are alternately arranged over the width direction thereof.
